(19) United States
(12) Patent Application Publication
(10) Pub. No.: US 2019/0332712 A1
(43) Pub. Date: Oct. 31, 2019

(54) SWITCH CONFIGURATION SYNCHRONIZATION

(71) Applicant: HEWLETT PACKARD ENTERPRISE DEVELOPMENT LP, Houston, TX (US)

(72) Inventors: Christopher Wild, Santa Clara, CA (US); Michael Zayats, Santa Clara, CA (US); Ganesh M. Iyer, Santa Clara, CA (US); Dhruv Shah, Santa Clara, CA (US)

(21) Appl. No.: 15/966,887

(22) Filed: Apr. 30, 2018

(51) Int. Cl. G06F 17/30; H04L 12/931; H04L 12/24

(52) U.S. Cl. CPC G06F 17/30581; G06F 17/30315; G06F 17/3033; H04L 41/0873; H04L 41/0813; H04L 41/0863; H04L 49/70

(57) ABSTRACT

Examples disclosed herein relate to a method comprising generating a first and a second set of unique identifiers for each row in each table of a first and second database, respectively. The first and second database may be configured to operate a first and second switch operating traffic on a network, respectively. The first switch and the second switch may be configured to operate traffic on the network. The method may also include creating a mapping between the first set of unique identifiers and the second set of unique identifiers and determining that a first row of the first database is marked to be synchronized, the first row corresponding to a first unique row ID. The method may also include retrieving, from a second row of the second database corresponding to a second unique row ID mapped to the first unique row ID and updating the second row.

### BACKGROUND

A network device, such as a switch, may be configured to operate network traffic in a desired way. It may be beneficial to have a back-up of this configuration data.

### BRIEF DESCRIPTION OF THE DRAWINGS

The following detailed description references the drawings, wherein:

FIG. 1A is a block diagram of an example system where switch configuration synchronization may be useful;

FIG. 1B is a block diagram of another example system for switch configuration synchronization;

FIG. 2 is a flowchart of another example method for mapping databases for switch configuration synchronization;

FIG. 3 is a flowchart of another example method for synchronizing databases for switch configuration;

FIG. 4 is a flowchart of an example method for switch configuration synchronization; and

FIG. 5 is a block diagram of another example system for switch configuration synchronization.

### DETAILED DESCRIPTION

Traditionally, a network device, such as a switch, may be configured by a text file or the like. For example, many switches may be configured via Command-Line Interface (CLI). In order to synchronize the configuration of the primary switch with a peer switch the text file may be transmitted from one switch to the other switch. In other words, the configuration data to be synchronized may be buffered up by the primary switch and transmitted to the peer switch. Once received, the configuration data may be saved to the configuration file of the peer switch.

However, there may be problems with this approach. For example, it may be difficult to reverse configuration changes, especially when numerous configurations changes are made simultaneous or in close time proximity. If numerous changes are made, there may be certain ordering dependencies. For example, if four changes are made, the first two may half to resolve before the third can take effect. If that third change needs to be reversed, the first two may need to be reversed as well. This may create numerous problems and prevent certain configuration changes from being reversed.

The present disclosure describes aspects of a switch configuration synchronization system that may identify configuration changes, map them quickly and identify any errors. A mapping may be created between the databases. A first mapping may be created on the primary database mapping the elements of the primary database to the peer database and a second mapping may be created on the peer database mapping the elements of the peer database to the primary database. With these two mappings created, changes between the two may be identified and identify areas that require attention. If a reference is missing, a specific error message may be flagged and a user may be presented with a request for the specific missing information, in this case, the reference.

In this manner, configuration changes can be performed by rolling back the database to a previous state. Once the database has been rolled back to a previous configuration, the configuration can be easily synchronized to a peer database. This may reduce or remove the dependency problems discussed above.

A benefit of the architecture is compatibility with modern protocols and standards. Whereas text bases configurations, such as CLI, may be a more rigid approach due to the ordering issues discussed above, aspects of the system disclosed herein may be better suited for modern programmable standards, such as REST, which would allow a user to programmatically set up events and responses using the configuration database as well as allow for customized logging.

Another benefit of the present disclosure may be that it allows for self-healing, whereas traditional text based methods may not be. Typically, before a textual configuration change is applied, the textual change may be tested for use on each device it is configure. In other words, a two-step roll out for configuration changes. In contrast, the present disclosure describes a one-step roll out. If there is a missing reference, you can push the change to the database and that change will automatically be synchronized and applied.

A method for switch configuration synchronization may include generating a first set of unique identifiers for each row in each table of a first database and a second set of unique identifiers for each row in each table of a second database, wherein the first database is configured to operate a first switch operating traffic on a network and the second database is configured to operate a second switch on the network, the first switch and the second switch configured to operate traffic on the network. The method may also include creating a mapping between the first set of unique identifiers and the second set of unique identifiers and determining that a first row of the first database is marked to be synchronized, the first row corresponding to a first unique row ID. The method may also include retrieving a second row of the second database corresponding to a second unique row ID mapped to the first unique row ID and updating the second row.

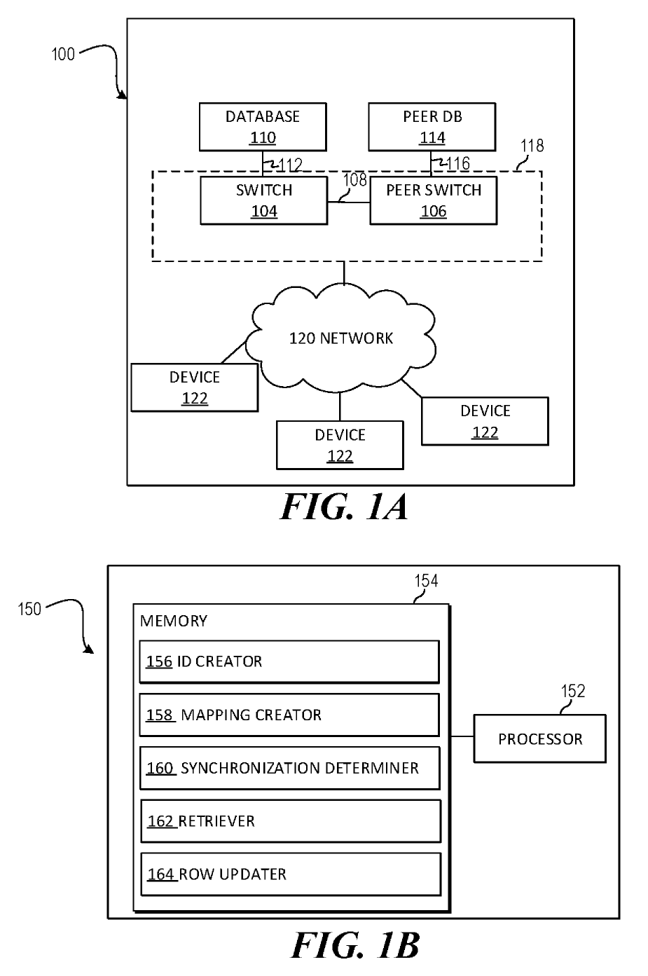

FIG. 1A is a block diagram of an example system 100 where switch configuration synchronization may be useful. System 100 may implement a database driven network switch architecture. The system 100 may include a primary switch 104 and a peer switch 106 connected by a link 108. Primary switch 104 may be connected to a database 110 via a link 112 and peer switch 106 may be connected to a peer database 114 via a link 116. Links 108, 112 and 116 may be a physical link, such as an Ethernet connection or other physical connection, a wireless connection, a virtual connection, etc.

A network switch, such as switch 104 and peer switch 106, may have routing capabilities such that the switch is responsible for routing data along a route (or equivalently, path) in a network 120. The switch may perform routing of data based on routing information accessible by the router. For example, the routing information can be stored on a storage medium of the router, or on a storage medium separate from but accessible by the router.

A database, such as a time series database 110 and peer database 114, may store some or all of the configuration, status, states and statistics of the network 120, the switches 104 and 106 and/or other devices on the network 120 at any given point at time. The different state data may be accessed from the databases 110 and 114 either individually (data for a given time, a given device, etc.) or in aggregate (data aggregated for particular items over a given time period, etc.). In other words, the state of the switch may be retrieved from any arbitrary state to any other arbitrary state by manipulating the database. The switch 104 and/or 106 may respond to these manipulations by reconfiguring itself to and perform any functionality required to achieve that state.

In this manner, the switches 104 and/or 106 access to numerous data points of information for devices 122 on the network 120 and the network 120 itself at different points in time. This also provides the switches 104 and/or 106 with a wide variety of information for monitoring, analysis, troubleshooting, etc.

In an environment utilizing a switch, there may be a need for a high availability. High availability may refer to a system and/or component that continuously operates for a long length of time. This time period may be represented as a percentage of uptime. For example, there may be a desirability to have a networking switch be available for 99.9% of up time. Of course this is an example percentage and other amounts of up time may be acceptable and/or desirable in a given environment.

The network 120 may also implement an active/active switching architecture. In this architecture, multiple switches, typically two (such as switch 104 and peer switch 106), are configured to service the network 120. In other words, the architecture includes two switches to mirror the traffic in between them and can act as an redundant system. If one switch goes down, the other can take over without a user having to take action.

Specifically, the primary switch 104 may access a primary database 110 configured to service the network 120. The peer switch 106, may access the peer database 114 and the peer database 114 may be synchronized to the primary database 110. The primary 104 and peer switch 106 may be connected to each other for control and data transfer. Moreover, the combination of the primary switch 104 and the peer switch 106 may be presented to the user as a single virtualized switch 118. In the event that the primary switch 104 goes down, no traffic may be lost, although the total amount of bandwidth available to the system may be reduced. Moreover, this architecture provides the ability to configure one switch 104 and have the configuration synced to the peer switch 106. This keeps the network facing elements consistent across management changes to allow for load balancing and high availability in case of failure.

Virtualized system 118 may allow a user to visualize and/or access the system 100 as a whole logically through one interface. The architecture may allow a user to discover certain conditions (such as anomalies, errors, etc.) in the system 100 in a programmable manner. Accordingly, a user may set certain database parameters, conditions in the network 120, for monitoring. For example, one or more VLANs may be monitored in the network (via, for example, a user created script). In the event that a VLAN in the network changes status (i.e. from active to non-active), a user and/or device may be notified, presented via a variety of information about the VLAN and devices running the VLAN as well as possible remedial actions to remedy the problem. In some aspects, these remedial actions may be automatically performed.

In addition to discovering and detecting events, anomalies, conditions, etc., errors may be dealt with programmatically. For example, if certain parameters meet certain conditions, certain actions to correct these parameters or other network conditions may be performed and/or a user may be notified to take manual intervention steps. Similarly, the parameters can be monitored over a certain period of time and the parameters can be compared over the period of time and/or compared to historical data. Additionally, a set of repeatable actions can be programmed to occur in certain circumstances based on the monitored parameters and/or other parameters. These automated responses may be programmed via REST, Ansible, as well as other scripting languages that can access data stored in a database.

Turning now to FIG. 1B, a block diagram of an example system 150 for switch configuration synchronization. System 150 may include a processor 152 and a memory 154 that may be coupled to each other through a communication link (e.g., a bus). Processor 152 may include a single or multiple Central Processing Units (CPU) or another suitable hardware processor(s). In some examples, memory 154 stores machine readable instructions executed by processor 152 for system 150. Memory 154 may include any suitable combination of volatile and/or non-volatile memory, such as combinations of Random Access Memory (RAM), Read-Only Memory (ROM), flash memory, and/or other suitable memory.

Memory 154 stores instructions to be executed by processor 152 including instructions for ID creator 156, mapping creator 158, synchronization determiner 160, retriever 162, row updater 164, and/or other components. According to various implementations, system 150 may be implemented in hardware and/or a combination of hardware and programming that configures hardware. Furthermore, in FIG. 1B and other Figures described herein, different numbers of components or entities than depicted may be used.

Processor 152 may execute ID creator 156 to create a unique string for each row in a first and second database. The first database may be configured to operate a first switch operating traffic on a network and the second database may be configured to operate a second switch on the network. Both the first and second switches may be configured, via the first and second databases, respectively, to actively manage the network. Processor 152 may execute mapping creator 158 to create a mapping between a first set of unique strings created for the first database and a second set of unique strings created for the second database. The first and the second switch may be configured to appear as a single virtual switch in a management pane.

Processor 152 may execute synchronization determiner 160 to identify a row from the first database that is marked to be synchronized. The first row may correspond to a first unique row ID. Processor 152 may execute retriever 162 to retrieve a second row of the second database corresponding to the identified row. Processor 152 may execute row updater 164 to update the second row.

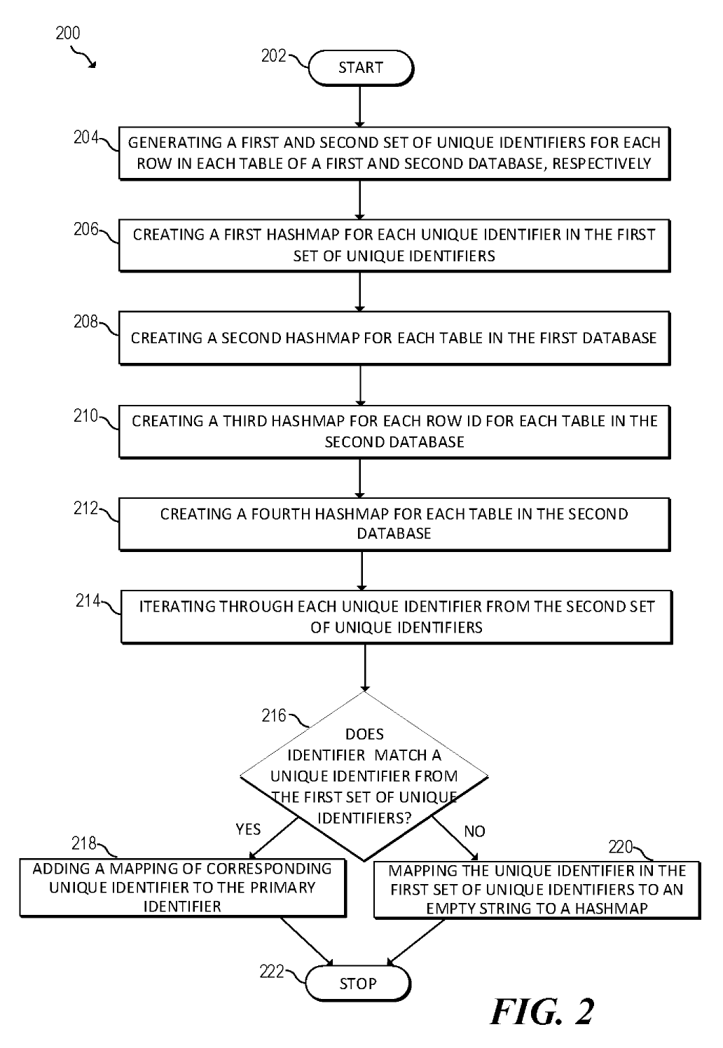

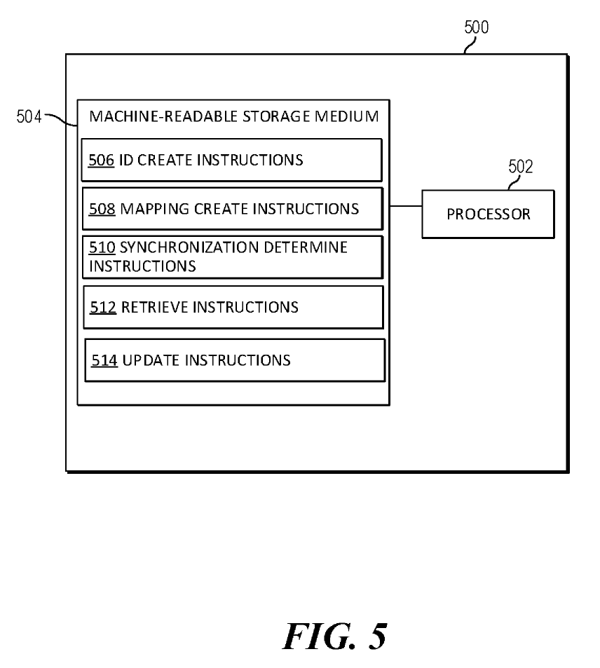

Referring now to FIGS. 2-4, flow diagrams are illustrated in accordance with various examples of the present disclosure. The flow diagrams represent processes that may be utilized in conjunction with various systems and devices as discussed with reference to the preceding figures, such as, for example, system 100 described in reference to FIG. 1A, system 150 described in reference to FIG. 1B and/or system 500 described in reference to FIG. 5. While illustrated in a particular order, the flow diagrams are not intended to be so limited. Rather, it is expressly contemplated that various processes may occur in different orders and/or simultaneously with other processes than those illustrated. As such, the sequence of operations described in connection with FIGS. 2-4 are examples and are not intended to be limiting. Additional or fewer operations or combinations of operations may be used or may vary without departing from the scope of the disclosed examples. Thus, the present disclosure merely sets forth possible examples of implementations, and many variations and modifications may be made to the described examples.

FIG. 2 is a flowchart of an example method 200 for mapping databases used in switch configuration synchronization. For example, method 200 may be used in an environment similar to system 100, described above in reference to FIG. 1A, to create a mapping between databases (such as a primary database and a peer database), used for configuring network switches. Sample database used in conjunction with the method and system of FIG. 1A may be an Open vSwitch Database (OVSDB). The databases may have a plurality of rows and unique identifiers for the rows.

Method 200 may start at block 202 and continue to block 204, where the method 200 may include generating a first set of unique identifiers, such as a identifier token string, for each row in each table of a first database and generating a first set of unique identifiers for each row in each table of a first database. Specifically, the method may include generating unique identifier token string for each row in each table for both the database instances based on index columns in a table. In this manner, a unique string is created for each row present in the database. This unique strings may be used (as will be described below) to algorithmic way match rows in one database to a second database. Each unique identifier in the database may have an associated index which depends on the schema definition of the respective table entry in the database. This index may be represented using a combination of index columns defined in the database schema. The index value may be computed using the content of such defined index values in the database.

At block 206, the method may include creating a first hashmap for each unique identifier in the first set of unique identifiers. The unique identifier may be used as the value for the first hashmap and the row ID (UUID) may be used as the key of the hashmap. At block 208, the method may include creating a second hashmap for each table in the first database. In the second hashmap, the table name may be used as the key and reference to the first hashmap may be used as the value. An example structure of this hashmap may look something like: PrimaryDatabaseUUIDCache: tableName→stringToken→rowUUID. The above discussed values and keys are for example use and other values and keys may be used.

At block 210, the method may include creating a third hashmap for each unique row id for each table in the second database. The third hashmap may include row ID(UUID) as the value for the hashmap and the unique identifier as the key. At block 212 the method may include creating a fourth hashmap for each table in the second database. The fourth hashmap may use the table name as the key and reference to the third hashmap as the value. An example structure of this hashmap may look something like: PeerDatabaseUUIDCache: tableName→rowUUID→stringToken. The above discussed values and keys are for example use and other values and keys may be used.

At block 214, the method may include iterating through each unique identifier from the second set of unique identifiers. At block 216, the method may include determining, for each unique identifier iterated through from the second set from the second database, whether the unique identifier matches a unique identifier from the first set of unique identifiers from the first database. If it is determined that there is a unique identifier in the first database that matches the unique identifier from the second database (Yes branch of block 216), at block 218 the method may include adding a mapping of corresponding unique identifier to the primary unique identifier to a hashmap. If it is determined that there is not a unique identifier (primary unique identifier) in the first database that matches the unique identifier (secondary unique identifier) from the second database (No branch of block 216), at block 220 the method may include mapping the unique identifier in the first set of unique identifiers to an empty string to a hashmap.

For example, the method may include iterating through the first and second hashmaps created for the primary database as well as the third and fourth hashmaps created for the peer database. At least one of the unique identifiers may be retrieved from the primary database and the method may include attempting to find a similar string token from the second set of unique identifiers. If the similar string token is found, then the matching unique identifiers are mapped in a fifth hashmap stored on the first database and/or a sixth hashmap stored on the second database. The fifth hashmap may be a mapping of the primary unique identifier to the secondary identifier. The sixth hashmap may be a mapping of the secondary unique identifier to the primary unique identifier. If the matching string token is not found then a fifth hashmap may be created on the first database having a key as the row ID and the value as an empty string. The empty string may be used to denote that the peer database has no row which matches the specific row on given database. The above discussed values and keys are for example use and other values and keys may be used. At block 222 the method may end.

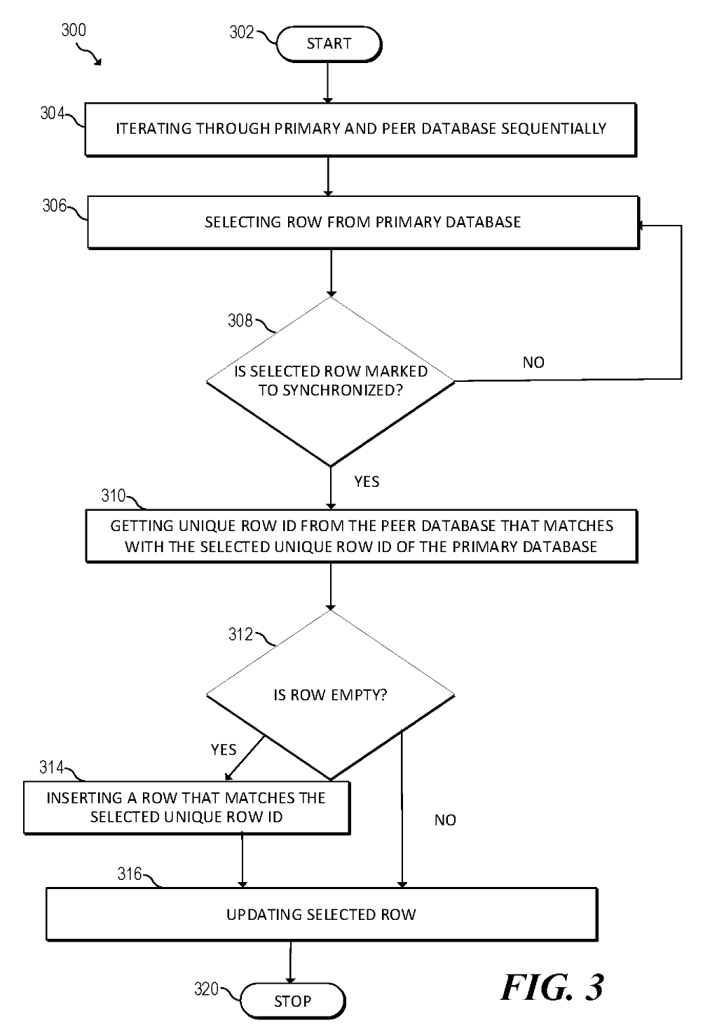

FIG. 3 is a flowchart of an example method 300 for synchronizing databases used in switch configuration. For example, method 300 may be used in an environment similar to system 100, described above in reference to FIG. 1A, to synchronize databases (such as a primary database and a peer database), used for configuring network switches, such as databases created using the method 200 described above in reference to FIG. 2. In this manner, the configuration data for the two switches can be synchronized such that either switch can be used to manage traffic on the network.

Method 300 may start at block 302 and continue to block 304, where the method 300 may include iterating through the primary and secondary database. For each row in the primary database, at block 306, a row may be selected and at block 308 the method may include determining whether the row is marked to be synchronized. If it is determined that the selected row is not marked to be synchronized (No branch of block 308), than the method may return to block 306 and another row may be selected.

If it is determined that the selected row is marked to be synchronized (Yes branch of block 308), than the method may proceed to block 310 where the method may include getting the unique row ID from the peer database that matches with the selected unique row ID of the primary database. The method may be easily able to determine the matching row by using mapping, such as mapping in the fifth and sixth hashmaps discussed above in reference to blocks 218 and 220 of method 200. As described above, the fifth hashmap may be a mapping of the primary unique identifier to the secondary identifier and the sixth hashmap may be a mapping of the secondary unique identifier to the primary unique identifier.

At block 312, the method may include determining whether the mapping shows that the row is empty on the peer database. As discussed above, in some aspects, a matching string token may not be found and a hashmap may be created having a key as the row ID and the value as an empty string. The empty string may be used to denote that the peer database has no row which matches the specific row on given database. If it is determined that the row on the peer database is empty (Yes branch of block 312), than the method may proceed to block 314, where the method may include inserting a row that matches the selected row on the primary database. Inserting the row may include creating an empty row and populating the empty row with the column values from the primary database.

After block 314 or if it is determined that the row on the secondary database is not empty (No branch of block 312), the method may proceed to block 316 where the method may include updating the existing row on the primary database. Updating the existing row may include creating a transaction with the changed/inserted rows and committing the transaction to the peer database. The method 300 may continue until each row in the primary has been iterated through and at block 320 the method may end. The method 300 may also be adapted to iterate through the peer database and synchronize rows from the primary database to the data in the peer database.

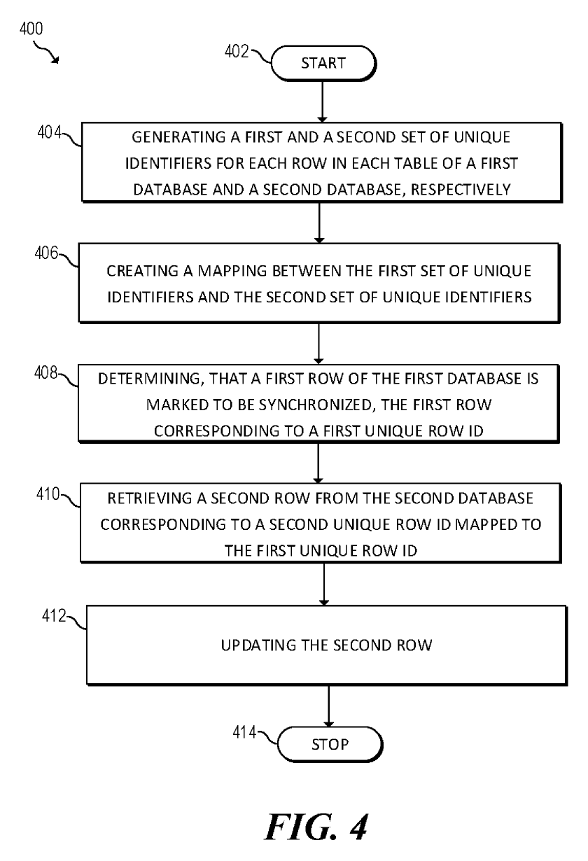

FIG. 4 is a flowchart of an example method 400 for switch configuration synchronization. Method 400 may start at block 402 and continue to block 404, where the method may include generating a first set of unique identifiers for each row in each table of a first database and a second set of unique identifiers for each row in each table of a second database. The first database may be configured to operate a first switch operating traffic on a network and the second database may be configured to operate a second switch on the network. The first switch and the second switch may be configured to operate traffic on the network. Both the first and the second switch may be configured, via the first and second databases, respectively, to actively manage the network. The first and the second switch may be configured to appear as a single virtual switch in a management pane.

At block 406, the method may include creating a mapping between the first set of unique identifiers and the second set of unique identifiers. At block 408, the method may include determining that a first row of the first database is marked to be synchronized and the first row may correspond to a first unique row ID. At block 410, the method may include retrieving a second row of the second database corresponding to a second unique row ID mapped to the first unique row ID. At block 412, the method may include updating the second row. The method may proceed to block 414, where the method may end.

FIG. 5 is a block diagram of an example system 500 for server configuration synchronization. In the example illustrated in FIG. 5, system 500 includes a processor 502 and a machine-readable storage medium 504. In some aspects, processor 502 and machine-readable storage medium 504 may be part of an Application-specific integrated circuit (ASIC). Although the following descriptions refer to a single processor and a single machine-readable storage medium, the descriptions may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 502 may be at least one central processing unit (CPU), microprocessor, and/or other hardware devices suitable for retrieval and execution of instructions stored in machine-readable storage medium 504. In the example illustrated in FIG. 5, processor 502 may fetch, decode, and execute instructions 506, 508, 510, 512 and 514 for server configuration synchronization. Processor 502 may include at least one electronic circuit comprising a number of electronic components for performing the functionality of at least one of the instructions in machine-readable storage medium 504. With respect to the executable instruction representations (e.g., boxes) described and shown herein, it should be understood that part or all of the executable instructions and/or electronic circuits included within one box may be included in a different box shown in the figures or in a different box not shown.

Machine-readable storage medium 504 may be any electronic, magnetic, optical, or other physical storage device that stores executable instructions. Thus, machine-readable storage medium 504 may be, for example, Random Access Memory (RAM), an Electrically-Erasable Programmable Read-Only Memory (EEPROM), a storage drive, an optical disc, and the like. Machine-readable storage medium 504 may be disposed within system 500, as shown in FIG. 5. In this situation, the executable instructions may be “installed” on the system 500. Machine-readable storage medium 504 may be a portable, external or remote storage medium, for example, that allows system 500 to download the instructions from the portable/external/remote storage medium. In this situation, the executable instructions may be part of an “installation package”. As described herein, machine-readable storage medium 504 may be encoded with executable instructions for context aware data backup. The machine-readable storage medium may be non-transitory.

Referring to FIG. 5, ID create instructions 506, when executed by a processor (e.g., 502), may cause system 500 to create a unique string for each row in a first and second database. The first database may be configured to operate a primary switch operating traffic on a network and the second database may be configured to operate a peer switch on the network. The primary switch and the peer switch configured to operate traffic on the network. Both the first and the second switch may be configured, via the first and second databases, respectively, to actively manage the network. The first and the second switch may be configured to appear as a single virtual switch in a management pane.

Mapping create instructions 508, when executed by a processor (e.g., 502), may cause system 500 to create a mapping between a first set of unique strings created for the first database and a second set of unique strings created for the second database. Synchronization instructions 510, when executed by a processor (e.g., 502), may cause system 500 to identify a row from the first database that is marked to be synchronized, the first row corresponding to a first unique row ID. Retrieve instructions 512, when executed by a processor (e.g., 502), may cause system 500 to retrieve a second row of the second database corresponding to a second unique row ID mapped to the first unique row ID. Update instructions 514, when executed by a processor (e.g., 502), may cause system 500 to update the second row.

The foregoing disclosure describes a number of examples for server configuration synchronization. The disclosed examples may include systems, devices, computer-readable storage media, and methods for server configuration synchronization. For purposes of explanation, certain examples are described with reference to the components illustrated in FIGS. 1A-5. The content type of the illustrated components may overlap, however, and may be present in a fewer or greater number of elements and components. Further, all or part of the content type of illustrated elements may co-exist or be distributed among several geographically dispersed locations. Further, the disclosed examples may be implemented in various environments and are not limited to the illustrated examples.

Further, the sequence of operations described in connection with FIGS. 1A-5 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples.

1. A method comprising:
generating a mapping between a first set of unique identifiers identifying a respective row of a first table of a first database and a second set of unique identifiers identifying a respective row of a second table of a second database, wherein the first database is configured to operate a first switch and the second database is configured to operate a second switch in a network, and wherein the first and second sets of unique identifiers are external to the first and second tables, respectively;
determining that a first row of the first table of the first database is marked to be synchronized, which indicates that the first row has been updated based on a configuration change of the first switch, wherein the first row corresponds to a first unique identifier of the first set of unique identifiers;
retrieving a second row of the second table of the second database corresponding to a second unique identifier of the second set of unique identifiers based on the mapping; and
updating the second row based on a value of the updated first row.

2. The method of claim 1, further comprising:
determining that the second row is empty; and
populating the second row with the value of the updated first row.

3. The method of claim 1, further comprising:
replacing a second value of the second row with a first value of the updated first row.

4. The method of claim 1, further comprising:
generating the first and second sets unique identifiers based on index columns in the first and second tables, respectively.

5. (canceled)

6. The method of claim 1, further comprising:
facilitating high availability for the first switch and the second switch; and
appearing as a single virtual switch in a management plane of the network.

7. The method of claim 1, comprising:
creating a first hashmap with the first unique identifier as a first value and a row identifier of the first row of the first table as a first key; and
creating a second hashmap, which includes a name of the first table as a second key and a reference to the first hashmap as a second value.

8. The method of claim 7, comprising:
creating a third hashmap with a row identifier of the second row of the second table as the third value and the second unique identifier as a third key;
creating a fourth hashmap, which includes a name of the second table as a fourth key and a reference to the third hashmap as a fourth value.

9. The method of claim 8, wherein generating the mapping comprises:
identifying, based on the first unique identifier in the first set of unique identifiers, the second unique identifier from the second set of unique identifiers by iterating through each of the first, second, third, and fourth hashmaps.

10. (canceled)

11. (canceled)

12. A computer system comprising:
a processor; and
a memory coupled to the processor and storing instructions, which when executed by the processor cause the processor to perform a method, the method comprising:
generating a mapping between a first set of unique identifiers identifying a respective row of a first table of a first database and a second set of unique identifiers identifying a respective row of a second table of a second database, wherein the first database is configured to operate a first switch and the second database is configured to operate a second switch in a network, and wherein the first and second sets of unique identifiers are external to the first and second tables, respectively;
determining that a first row of the first table of the first database is marked to be synchronized, which indicates that the first row has been updated based on a configuration change of the first switch, wherein the first row corresponds to a unique identifier of the first set of unique identifiers;
retrieving a second row of the second table of the second database corresponding to a second unique identifier of the second set of unique identifiers based on the mapping; and
updating the second row based on a value of the updated first row.

13. The computer system of claim 12, wherein the method further comprises:
facilitating high availability for the first switch and the second switch; and
appearing as a single virtual switch in a management plane of the network.

14. The computer system of claim 12, wherein the method further comprises:
creating a first hashmap with the first unique identifier as a first value and a row identifier of the first row of the first table as a first key;
creating a second hashmap, which includes a name of the first table as a second key and a reference to the first hashmap as a second value;
creating a third hashmap with a row identifier of the second row of the second table as the third value and the second unique identifier as a third key; and
creating a fourth hashmap, which includes a name of the second table as a fourth key and a reference to the third hashmap as a fourth value.

15. The computer system of claim 14, wherein generating the mapping comprises:
identifying, based on the first unique identifier in the first set of unique identifiers, the second unique identifier from the second set of unique identifiers by iterating through each of the first, second, third, and fourth hashmaps.

16. (canceled)

17. (canceled)

18. A non-transitory machine-readable storage medium encoded with instructions, the instructions executable by a processor of a system to cause the system to perform a method, the method comprising:
generating a mapping between a first set of unique identifiers identifying a respective row of a first table of a first database and a second set of unique identifiers identifying a respective row of a second table of a second database, wherein the first database is configured to operate a first switch and the second database is configured to operate a second switch in a network, and wherein the first and second sets of unique identifiers are external to the first and second tables, respectively;
determining that a first row of the first table of the first database is marked to be synchronized, which indicates that the first row has been updated based on a configuration change of the first switch, wherein the first row corresponds to a first unique identifier of the first set of unique identifiers;
retrieving a second row of the second table of the second database corresponding to a second unique identifier of the second set of unique identifiers based on the mapping; and
updating the second row based on a value of the updated first row.

19. The non-transitory machine-readable storage medium of claim 18, wherein updating the second row further comprises one of:
determining that the second row is empty
populating the second row with a value of the first row; and
replacing a second value of the second row with a first value of the updated first row.

20. (canceled)

21. The method of claim 1, further comprising:
obtaining a new configuration for the first switch, wherein the new configuration generates the configuration change of the first switch; and
storing the new configuration in the first row.

22. The method of claim 1, further comprising:
detecting an error associated with the first switch; and
generating, for the error, a corrective action that generates the configuration change of the first switch.

23. The method of claim 1, further comprising rolling back configuration for the first switch to a stable state, wherein the rolling back generates the configuration change of the first switch.

24. The computer system of claim 12, wherein updating the second row further comprises one of:
determining that the second row is empty and populating the second row with the value of the updated first row; and
replacing a second value of the second row with a first value of the updated first row.

25. The computer system of claim 12, wherein the configuration change of the first switch corresponds to one of:
a new configuration for the first switch, wherein the new configuration is stored in the first row;
a corrective action for an error associated with the first switch; and
a roll back of the configuration of the first switch to a stable state.

26. The non-transitory machine-readable storage medium of claim 18, wherein the configuration change of the first switch corresponds to one of:
a new configuration for the first switch, wherein the new configuration is stored in the first row;
a corrective action for an error associated with the first switch; and
a roll back of the configuration of the first switch to a stable state.
